(19) United States
(12) Patent Application Publication
(10) Pub. No.: US 2015/0100515 A1
(43) Pub. Date: Apr. 9, 2015

(54) CUSTOMER DATA UNIFICATION

(71) Applicant: TATA CONSULTANCY SERVICES LIMITED, Mumbai (IN)

(72) Inventors: Siyo George, Ernakulam District (IN); Bharatharajan Radhakrishnan, Kochi (IN); Sudeesh Kumar, Pathanamthitta (IN); Sunitha Mayelil Muralidharn, Ernakulam District (IN)

(21) Appl. No.: 14/505,218

(22) Filed: Oct. 2, 2014

(30) Foreign Application Priority Data
Oct. 3, 2013 (IN) 3153/MUM/2013

(51) Int. Cl. G06Q 10/06; G06F 17/30

(52) U.S. Cl. CPC G06Q 10/067; G06F 17/30946
USPC 705/342

(57) ABSTRACT

The present subject matter discloses a customer data unification system, implemented in a big data platform, for unification of customer data. In an embodiment, the customer data unification system includes a data operation module and an identity resolution module, both coupled to a processor. The data operation module obtains organizational customer data and social customer data organizational data sources and social media sources, respectively. The unstructured data from the organizational customer data and social customer data is processed for standardization and de-duplication. Further, the identity resolution module determine an identity resolution value for the social customer data to determine a similarity between the organizational customer data and the social customer data. Subsequently, the organizational customer data and the social customer data are unified.

### TECHNICAL FIELD

The present subject matter relates, in general, to data processing and, particularly but not exclusively, to unification of customer data of an organization implementing big data platform.

### BACKGROUND

The dynamic nature of the global business scenario and increased customer awareness has occasioned a highly competitive environment for business organizations. As the competition grows fierce with time, the business organizations have realized that one of the ways of rapidly progressing on the path of success is by valuing the customers. Therefore, business organizations have begun channeling a considerable amount of effort in understanding the customers and their preferences. Accordingly, conventionally, various organizations deploy tools for mining internal databases to obtain customer data, such as feedback, complaints, and grievances, to improve the quality of products and services offered to the customers.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network implementation of a customer data unification system implemented in a big data platform for unification of customer data of an organization, in accordance with an embodiment of the present subject matter.

FIG. 2A illustrates the customer data unification system for unification of customer data, in accordance with an embodiment of the present subject matter.

FIG. 2B illustrates flow of data for identity resolution by the customer data unification system, in accordance with an embodiment of the present subject matter.

FIG. 3 illustrates a method for unification of customer data of an organization implementing big data platform, in accordance with an embodiment of the present subject matter.

### DETAILED DESCRIPTION

The present subject matter relates to unification of customer data of an organization implementing big data platform.

Conventionally, business organizations use various techniques for gaining a perspective on preferences and opinions of customers regarding their products and services. According to certain conventional techniques, a business organization obtains and parses information from internal databases to retrieve data, such as feedback, complaints, and grievances, to improve the quality of products and services offered to the customers. In few other conventional techniques, the business organization may obtain data associated with the customer from various social media channels, such as networking portals and discussion forums. However, the business organizations are usually unable to connect the customer data obtained from the two sources.

In certain cases, while some portion of the data from social media channels may be employed to complement the organizational data associated with the customer, owing to the complexity of identifying the customer on various social media forums, the data retrieved from the social media channels may be associated erroneously with a different user. As a result, the results of the exercise of obtaining an in-depth perspective regarding the customer may be misleading, and may adversely affect the progress of the business organization. Consequently, the entire exercise carried out by investing huge amounts of technical and financial resources, may turn out to be futile.

The present subject matter describes methods and systems for unification of customer data of an organization implementing big data platform. In an implementation, organizational data associated with the customer is retrieved, on the basis of which social media data associated with the customer is retrieved. The former is referred to as the organizational customer data, whereas the latter is referred to as the social customer data. The organizational data and the social media data associated with the customer are retrieved onto the big data platform for effectively regulating the processing of data for unification. Further, the identity of the customer for whom the social media data is retrieved is verified, based on the organizational data. Subsequently, the organizational customer data and the social customer data are used for obtaining inferential attributes associated with the customer. In an example, the inferential attributes can be indicative of preferences of the customer with respect to various products and services offered by the organization. The big data platform, therefore, facilitates in handling and managing the large amount of data and processing involved as part of unification of the customer data.

In an implementation, the retrieval of the organizational customer data is initiated by obtaining seed data associated with a customer profile from organizational data sources. In an example, the seed data can include primary information regarding the customer, say name, sex, and date of birth. Based on the seed data, the organizational customer data is obtained. In an implementation, the organizational data sources from which the organizational customer data is obtained can be structured as well as unstructured data sources. Accordingly, the organizational customer data includes structured as well as unstructured organizational customer data. In one example, the structured data sources can include customer relationship management (CRM) systems and master data management (MDM) systems, whereas the unstructured sources of data can include click-stream logs and customer communications, say electronic mails and online chats, exchanged between the customer and the organization.

Further, from the organizational customer data, certain data is selected for obtaining information regarding the customer from social media sources and channels. In one example, the data so selected for obtaining social customer data can be selected from the structured organizational data. In another example, the seed data can be used for obtaining the social customer data. Subsequently, the data associated with the customer and publically available on various social media sources and channels is obtained. In an example, the social customer data obtained from the social media sources is in unstructured format.

According to an implementation, the unstructured data obtained from various sources is processed, say for cleaning, on the big data platform, before the data can be further used. In said implementation, standardization of the unstructured organizational customer data and the unstructured social customer data is achieved so that the data is in similar format for further processing. In addition, the unstructured organizational customer data and the unstructured social customer data can be processed for de-duplication, i.e., for removing duplicate data from the records. The data obtained after processing the unstructured organizational customer data and the unstructured social customer data is referred to as intermediate organizational customer data and intermediate social customer data, respectively.

As mentioned previously, to handle the large amounts of data obtained from various sources, the big data platform implemented in the organization is brought to use. Accordingly, subsequent to the processing, the structured organizational customer data, the intermediate organizational customer data, and the intermediate social customer data is stored on an intermediate data store for further operations. In an example, the intermediate data store is non-relational, dynamic database. Further, according to an embodiment of the present subject matter, at the intermediate data store, identity resolution is achieved for the customer profile. The identity resolution is achieved to determine whether the data obtained from social media sources is for the same customer for whom the organizational data is retrieved.

In an implementation, for confirming that the data obtained from various sources belongs to the same customer, an identity resolution value for the intermediate social customer data is determined. For instance, the intermediate social customer data can include various customer profiles, and the identity resolution is achieved for each of the customer profiles. In one example, for determining the identity resolution value, the attributes in the seed data are used. In said example, for each attribute in the seed data, corresponding attribute from the intermediate social customer data is retrieved, and compared to determine the identity resolution value. In another example, a few attributes from the seed data can be selected and corresponding attributes from the intermediate social customer data can be retrieved, and the two compared for determining the identity resolution value. In another case, the identity resolution value can be determined by retrieving each selected attribute from the intermediate social customer data and the structured organizational customer data from the organizational data and comparing the two.

In an implementation, an identity resolution value can be determined based on the comparison of each of the attributes, and an overall identity resolution value can be determined based on the identity resolution values of the individual attributes. Further, in one example, a weight can be associated with each of the individual attributes, based on a uniqueness of value of the selected attribute, and the overall identity resolution value can be determined based on the individual weights. The identity resolution value, as would be understood from the foregoing description, is indicative of similarity between the organizational customer data and the social customer data. In one case, the identity resolution value is compared against a threshold value and the intermediate social customer data for which the identity resolution value is determined to be equal or greater than the threshold value is used further. As will be understood, the intermediate social customer data for which the identity resolution value is less than the threshold value is discarded. The intermediate social customer data selected for further use, in response to identity resolution, is referred to as refined social customer data.

As a result of identity resolution, the present subject matter ensures that the errors due to mismatch in the customer data retrieved from organizational sources and the social media sources, are prevented. The data obtained subsequent to standardization, de-duplication, and identity resolution is robust in nature, and accordingly, the information retrieved from the entire procedure is valuable information indicative of the customer likes and dislikes, and can be effectively used by the organization for developing business strategies.

Further, in another implementation of the present subject matter, the identity resolution for the customer can be achieved for intermediate organizational customer data in addition to the intermediate social customer data, in the same manner as described above. Accordingly, in such a case, the intermediate organizational customer data selected for further use, in response to identity resolution, and the structured organizational customer data are collectively referred to as refined organizational customer data. In another case, in which the identity resolution is not achieved for the intermediate organizational customer data, the entire intermediate organizational customer data and the structured organizational customer data collectively form the refined organizational customer data.

Subsequent to identity resolution, the refined organizational customer data and the refined social customer data associated with the customer profile is transferred on to a refined data store, for determining inferential attributes. At the refined data store, the refined organizational customer data and the refined social customer data are unified to obtain a comprehensive data collection regarding the customer. In an example, the refined data store can be a dynamic database similar to the intermediate data store. In an example, the refined data store can include a master record of customer profiles and data having a record of customer attributes obtained from various data sources. As mentioned previously, the refined data store is built as a schema-less, parallel database. Accordingly, at the refined data store, all the customer data from various sources can be accumulated. In addition, a history associated with each attribute in the customer data, for instance, when was that attribute received and the source of the attribute, can be maintained at the refined data store. As a result, in one example, the refined data store is provided as having a columnar structure. The columnar structure allows the refined data store to keep a chronological record of the customer data, with a schema-less architecture. Further, according to an aspect, the data on the refined data store can be checked for removal of duplicates before the inferential attributes are determined.

Further, according to an aspect, the entire integrated data set formed from the refined social customer data and the refined organizational customer data, is used for obtaining an insight on the customer perspective regarding the products and services of the organization, inclination of the customer towards competitive products, influence of the customer in social media, and viewpoints of the customer on aspects related to the line of business of the organization. Accordingly, in an implementation, the inferential attributes associated with the customer profile are determined based on the refined organizational customer data and the refined social customer data. In said implementation, the inferential attributes can be determined by applying data analytics techniques to the unified data, i.e., the refined organizational customer data and the refined social customer data. In an example, the data analytics techniques can include expression handling techniques, event extraction techniques, opinion mining techniques, sentiment analysis techniques, named entity extraction techniques, and social influence indicator techniques.

As mentioned previously, the inferential attributes, so determined, can be indicative of the preferences of the customer with reference to the products and services of the organization and the competitor and relationship of the customer in social online circles. Further, the results of the data analytics processing of the customer data can be provided to the organization for further use. In one example, the refined organizational customer data, the refined social customer data, and the inferential attributes associated with the customer profile can be displayed on a display unit, say a screen. In addition, the present subject matter provides for integration of the refined customer data, and the inferential attributes with business intelligence tools, for facilitating development of business processes. Accordingly, the present subject matter allows the organization to obtain an in-depth perspective on the customer based on organizational and social customer data, and facilitates the organization to leverage the same for business purposes.

These and other advantages of the present subject matter would be described in greater detail in conjunction with the following figures. While aspects of described systems and methods can be implemented in any number of different computing systems, environments, and/or configurations, the embodiments are described in the context of the following device(s).

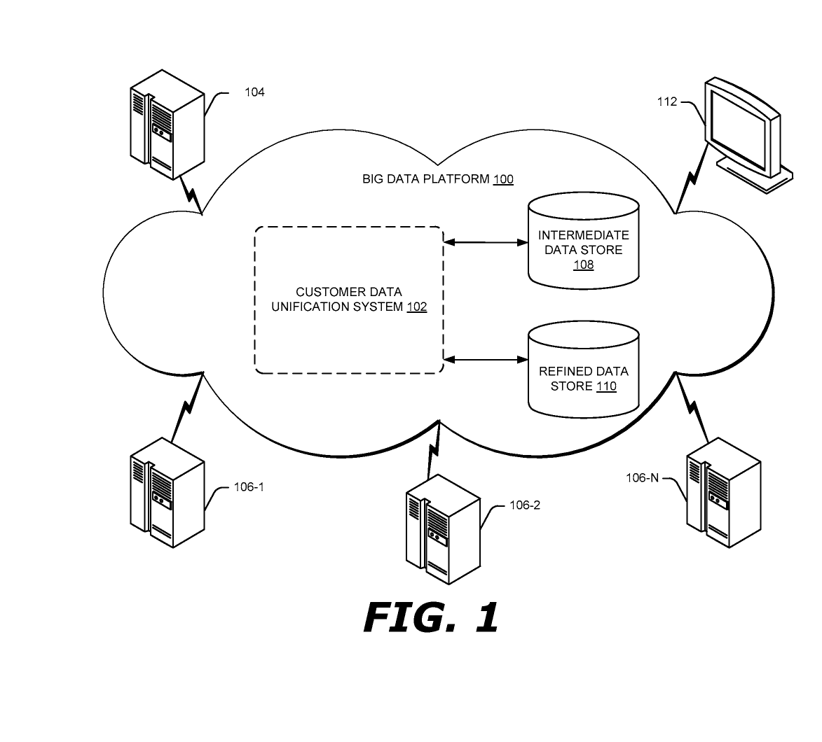

FIG. 1 illustrates a network implementation of a big data platform 100 having a customer data unification system 102 for unification of customer data associated with an organization, in accordance with an embodiment of the present subject matter. In an example, the organization can be a business establishment or a financial institution. In an implementation, the customer data to be unified can include organizational and social media data associated with the customer. The former is referred to as the organizational customer data, whereas the latter is referred to as the social customer data. The organizational data and the social media data associated with the customer are retrieved onto the big data platform 100 for regulating the processing of unification of the data. The big data platform 100 is adapted to manage large amounts of data, which is involved in such unification.

Accordingly, the big data platform 100 can be connected to an organizational data source 104 for obtaining the organizational customer data associated with the customer, and one or more social media sources 106-1, 106-2, . . . 106-N for obtaining the social customer data. For the sake of brevity, the social media sources 106-1, 106-2, . . . 106-N are individually referred to as social media source 106 and collectively referred to as social media sources 106, hereinafter. As would be understood from the foregoing description, the organizational data source 104 can be implemented as an internal database of the organization. In one example, the organizational data source 104 can include structured as well as unstructured internal data sources of the organization. Accordingly, in said example, the organizational data source 104 can include customer relationship management (CRM) systems and master data management (MDM) systems, as well as click-stream logs and customer relationship communication logs, say electronic mails (e-mails), telephonic conversations, online chats, and exchanged between the customer and the organization. Further, in an example, the social media sources 106 usually include unstructured data sources, such as social networking portals, blogs, and discussion forums.

Further, in an example, the big data platform 100 can be implemented in the form of a high-availability distributed object-oriented platform (HADOOP) framework. Accordingly, in said example, the customer data unification system 102, referred to as system 102, can be implemented as having one or more master nodes coupled to a cluster of slave nodes, and having a HADOOP framework file system (HDFS). In addition, the big data platform 100 can include an intermediate data store 108 and a refined data store 110, for assisting operation of the system 102 in customer data unification. In one example, the intermediate data store 108 can be implemented as a non-relational, dynamic database having columnar structure. In addition, in an example, the refined data store 110 can be implemented in a similar manner as the intermediate data store 108. Such databases do not have a predefined schema or a specific data type, and are scalable based on the amount of information to be stored, i.e., columns can be or removed from the database, for accommodating the data.

In operation, as mentioned above, the system 102 can integrate the organizational customer data and the social customer data, to provide a comprehensive insight regarding the customer, say with reference to products and services offered by the organization, competitor products and services, and on related aspects. In order to obtain such an in-depth insight, according to an aspect, the system 102 can obtain inferential attributes associated with the customer from the organizational customer data and the social customer data. In one implementation, for sourcing the customer data from various sources, the big data platform 100 can include enterprise adaptors. In one example, the enterprise adaptors can be implemented in the system 102. In addition, to prevent errors from occurring in the results of such unification, the system 102 can achieve identity resolution for the customer to ensure that the data obtained from different sources belongs to the same individual.

In an implementation, upon receiving the customer data from different sources, the system 102 can perform operations on the data, say for standardization and for removal of duplication from the data. In one case, such operations can be performed on the unstructured organizational customer data and the unstructured social customer data. The data obtained after the operations is substantially devoid of duplicates and is in the same format, and can be used for further processing. Further, the data obtained after performing the above mentioned operations on unstructured social customer data is referred to as intermediate social customer data, and the data obtained after performing the above mentioned operations on the unstructured organizational customer data is referred to as the intermediate organizational customer data. In another case, the structured organizational customer data can also be processed for standardization and removing the duplicates. In such a case, the intermediate organizational customer data can include the processed structured organizational customer data.

Coming back to the previous implementation, subsequently, the system 102 stores the intermediate customer data, i.e., the intermediate social customer data and the intermediate organizational customer data, and the structured organizational data, on the intermediate data store 108, where the intermediate customer data is used for identity resolution. While in said implementation, the intermediate data store 108 is shown as a single repository, in other implementations, separate intermediate data stores can be provided for the organizational customer data and the social customer data, and the data from the separate intermediate data stores is taken to the refined data store 110 for unification.

As mentioned previously, the identity resolution is achieved for the customer to determine whether the data obtained from the social media sources is for the same customer for whom the organizational data is obtained. In an implementation, the system 102 can select a plurality of attributes, say from seed data, for identity resolution and obtain details regarding the selected attributes from the intermediate social customer data and the seed data. Further, the system 102 can compare details from the intermediate social customer data and the seed data for each selected attribute and determine the similarity between the two data sets. In another example, the system 102 can select the plurality of attributes from the seed data and can obtain similar attributes from the structured organizational customer data for comparison with the intermediate social customer data, for identity resolution.

In one implementation, the system 102 can ascertain an identity resolution value based on the comparison between the details from the two data sets. In said implementation, the system 102 can associate a weightage with each of the selected attributes for identity resolution, and the system 102 can take into account the weightages of each attribute for determining the identity resolution value. In an example, the weightage can be associated with each attribute based on a uniqueness of the value that the attribute can have, i.e., the more unique is the value of the attribute, the greater is the weightage associated with that attribute.

In addition, the identity resolution value can be compared to a predetermined threshold value, and if the identity resolution value meets a predetermined threshold value, the social customer data can be considered as belonging to the same customer. Accordingly, the intermediate social customer data which is so determined to belong to the same customer, based on the identity resolution value, is used further, and the rest of the intermediate social customer data is discarded. The intermediate social customer data selected for further use, in response to identity resolution, is referred to as refined social customer data.

In one implementation, the system 102 can achieve such identity resolution for the intermediate organizational customer data, and the intermediate organizational customer data selected for further use is referred to as refined organizational customer data. In addition, the structured organizational customer data which is to be further used is also part of the refined organizational customer data. In another case, in which the identity resolution is not achieved from intermediate organizational customer data, the intermediate organizational customer data and the structured organizational customer data can be collectively form the refined organizational customer data.

Once the identity resolution is achieve, the system 102 can transfer the refined customer data, say from the intermediate data store 108, to the refined data store 110, for further operation. At the refined data store 110, the entire unified data set formed from the refined social customer data and the refined organizational customer data, is used for obtaining an insight on the customer perspective regarding the products and services of the organization, inclination of the customer towards competitive products, influence of the customer in social media, and viewpoints of the customer on aspects related to the line of business of the organization.

Accordingly, at the refined data store 110, the system 102 determines the inferential attributes associated with the customer and indicative of, say the inclination of the customer towards the products and services offered by the organization. According to one implementation, the system 102 applies data analytics techniques to the unified refined customer data to determine the inferential attributes providing an in-depth analysis of the unified data with reference to the customer's point-of-view on the organization's services and products. In an example, the system 102 can make use of expression handling techniques, event extraction techniques, opinion mining techniques, sentiment analysis techniques, named entity extraction techniques, and social influence indicator techniques, to determine the inferential attributes.

Further, in an implementation, the system 102 can provide the inferential attributes and the refined customer data in different formats for further use. In one implementation, the big data platform 100 can be coupled to a display unit 112 on which the system 102 can render the results of data unification, i.e., the inferential attributes and the refined customer data, for viewing. Accordingly, the results can be appropriately used by the organization for business purposes, such as for strategizing business processes and rolling out new products in the market. In another implementation, the system 102 can provide for integration of the results of data unification with various business intelligence tools, and indicate the output of the business intelligence tools on the display unit 112.

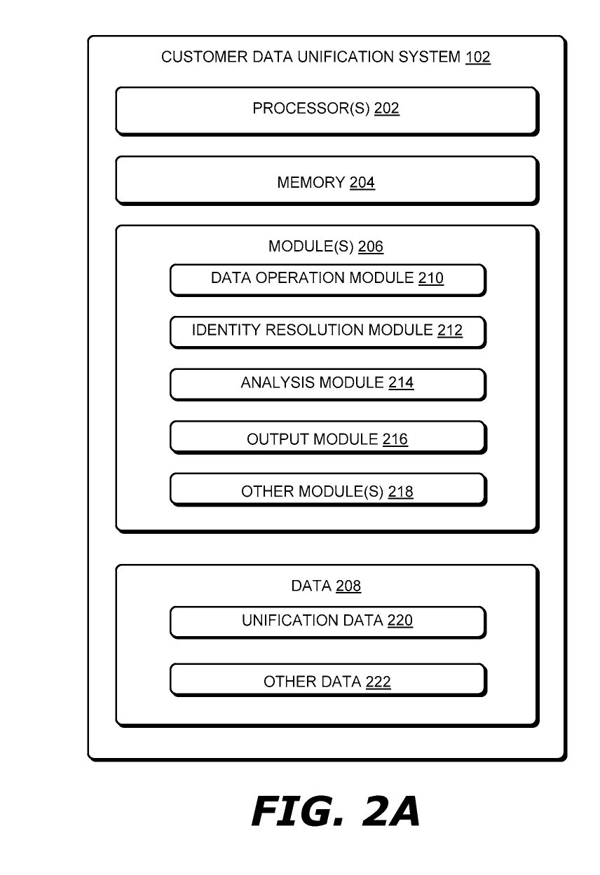

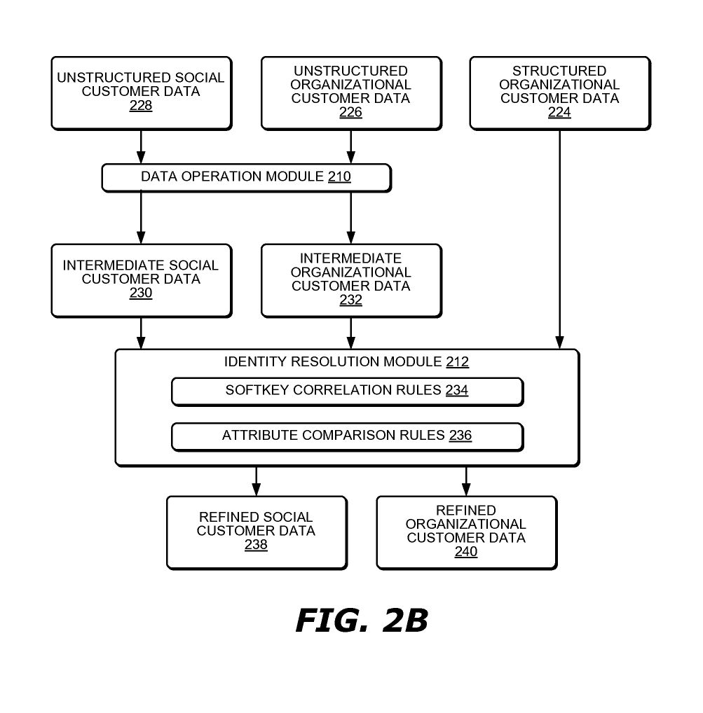

FIG. 2A illustrates the customer data unification system 102 for unification of customer data, referred to as the system 102 hereinafter, in accordance with an embodiment of the present subject matter. As mentioned previously, the system 102 can be implemented in the big data platform 100 as a HADOOP cluster and can comprise a plurality of master nodes and slave nodes for facilitating the operation of the system 102 for unification of the customer data. Accordingly, the various functions for unification of customer data can be divided between the master nodes and the cluster of slave nodes, in accordance with the operation of the various components of a HADOOP framework. However, for ease of understanding, clarity, and brevity, the system 102 is illustrated as having functional units, instead of showing individual components of the system 102.

In one implementation, the system 102 includes processor(s) 202 and memory 204. The processor(s) 202 may be implemented as one or more microprocessors, microcomputers, microcontrollers, digital signal processors, central processing units, state machines, logic circuitries, and/or any devices that manipulate signals, based on operational instructions. Among other capabilities, the processor(s) is provided to fetch and execute computer-readable instructions stored in the memory 204. As will be understood with reference to the foregoing description, the processor(s) 202 represent the processing units of the various components, such as the master nodes and the slave nodes, of the system 102. Further, the memory 204 may be coupled to the processor 202 and can include any computer-readable medium known in the art including, for example, volatile memory, such as Static Random Access Memory (SRAM) and Dynamic Random Access Memory (DRAM), and/or non-volatile memory, such as Read Only Memory (ROM), erasable programmable ROM, flash memories, hard disks, optical disks, and magnetic tapes.

Further, the system 102 may include module(s) 206 and data 208. The modules 206 and the data 208 may be coupled to the processors 202. The modules 206, amongst other things, include routines, programs, objects, components, data structures, etc., which perform particular tasks or implement particular abstract data types. The modules 206 may also, be implemented as, signal processor(s), state machine(s), logic circuitries, and/or any other device or component that manipulate signals based on operational instructions. As mentioned previously, the modules 206 can be implemented as being distributed in the HADOOP cluster of the system 102; however, for the sake of brevity and clarity, the modules 206 are shown as an integrated unit of the system 102.

In an implementation, the module(s) 206 include data operation module 210, an identity resolution module 212, an analysis module 214, an output module 216, and other module(s) 218. The other module(s) 218 may include programs or coded instructions that supplement applications or functions performed by the system 102. Additionally, in said implementation, the data 208 includes a unification data 220 and other data 222. The other data 222 amongst other things, may serve as a repository for storing data that is processed, received, or generated, as a result of the execution of one or more modules in the module(s). In an example, the data 208 can be a part of the HADOOP distributed file system (HDFS) distributed over the cluster of nodes of the system 102, and shown as a single integrated data system in the figure.

In operation, as mentioned previously, the system 102 obtains customer data from various disparate sources, including structured organizational data sources, unstructured organizational data sources, and social media sources, and integrates usable customer data for further use for the organization. As part of integrating the customer data, the system 102 achieves identity resolution to ensure that the customer data retrieved from the various sources is associated with the same individual or customer. In said implementation, the sourcing of the customer data from the various data stores is achieved by the data operation module 210 and the further processing of the customer data for identity resolution of the customer is achieved by the identity resolution module 212. The operation of the data operation module 210 and the identity resolution module 212 is described with reference to FIG. 2B.

FIG. 2B illustrates the flow of data from the various data sources through the data operation module 210 to the identity resolution module 212, in accordance with an implementation of the present subject matter. In said implementation, the data operation module 210 can obtain customer data from the organizational data source 104 and the social media sources 106.

As mentioned previously, the organizational customer data can be in structured as well as unstructured format. In an example, the structured organizational customer data 224 can be sourced from the customer relationship management (CRM) systems and the master data management (MDM) systems. Further, in one example, the unstructured organizational customer data 226 can be sourced from click-stream logs, customer relationship communication logs, such as emails, chats, and telephonic conversations. For instance, in case the customer is a member of or associated with a privileged customer group, say frequent flier group, then such information forms part of the unstructured organizational customer data 226.

On the other hand, the social media data sourced by the data operation module 210 is usually in unstructured format. For instance, the data operation module 210 can source the unstructured social customer data 228 from various publically accessible social media channels, including networking portals, blogs, discussion forums, chat groups, and click stream logs of various such portals and forums. In addition, in an example, the data operation module 210 can source the unstructured social customer data 228 from published articles and research papers which include enough information for determining identity of the author. For example, if the published articles or papers include the name, phone number, and email address of the author, then it can be sourced by the data operation module 210. According to an implementation, the data operation module 210 can select certain attributes from the already obtained organizational customer data 224, 226, and use the selected organizational customer data 224, 226 to source the data from the social media sources 106.

In one example, the data operation module 210 can be implemented as an enterprise adaptor, for connecting to the organizational data source 104 and the social media sources 106, and parse customer data from such data sources 104 and 106. The data operation module 210 is the first point of entry of the customer data into the big data platform 100. In said implementation, the data operation module 210 can first obtain seed data to initiate the sourcing of data. In one instance, the seed data can include the basic information relating to the customer, say name, date of birth, sex, and place of birth.

Further, the data operation module 210 can perform various operations on the customer data 224, 226, 228, say for standardizing and removing duplicates in the customer data 224, 226, 228. In one implementation, the data operation module 210 can obtain the customer data 224, 226, 228 in JavaScript Object Notation (JSON) format and standardize the customer data 224, 226, 228 into text format. In said implementation, the data operation module 210 can temporarily store the customer 224, 226, 228 for performing the data operations as mentioned above.

In one example, the data operation module 210 can perform the operations for standardization and removal of duplicates on the unstructured organizational customer data 226 and the unstructured social customer data 228. In another example, data operation module 210 can perform similar data operations on the structured organizational customer data 224. The data obtained after performing the above mentioned operations on unstructured social customer data 228 is referred to as intermediate social customer data 230, and the data obtained after performing the above mentioned operations on the unstructured organizational customer data 226 is referred to as the intermediate organizational customer data 232. In another implementation, as mentioned above, the intermediate organizational customer data 232 can either include the processed unstructured organizational customer data 226 and the processed structured organizational customer data 224.

In addition, the data operation module 210 can populate the intermediate data store 108 with the intermediate social customer data 230 and the intermediate organizational customer data 232. Therefore, the data operation module 210 functions as a data parser, performs data processing, and populates the intermediate data store 108 with the intermediate customer data 230 and 232, and the structured customer data 224.

Further, in one implementation, as shown in FIG. 2B, the identity resolution module 212 can achieve identity resolution for the customer, to ascertain that the customer data, say the intermediate social customer data 230, belongs to the same customer for whom the entire exercise of data unification is being performed. According to an implementation, the identity resolution module 212 can select one or more attributes associated with the customer profile from seed data, and achieve identity resolution based on the selected attributes. In one example, the identity resolution module 212 can retrieve the selected attributes from the intermediate social customer data 230 and retrieve the corresponding attributes from the seed data, and compare each corresponding attribute for identity resolution. In another example, the identity resolution module 212 can retrieve the selected attributes from the intermediate social customer data 230 and retrieve the corresponding attributes from the structured organizational customer data 224, and compare the corresponding attributes for identity resolution. In one example, the identity module 212 can include a plurality of softkey correlation rules which can provide for comparison and analysis of strings that the attributes are comprised of. In an example, the softkey correlation rules can be based on softkey correlation techniques, such as Jaro-Winkler technique, Cosine Similarity technique, Overlapping Qgrams technique, Monge-Elkan technique, Soundex algorithm technique, and Abbreviations algorithm technique.

Further, according to an aspect of the present subject matter, the identity resolution module 212 can achieve identity resolution by determining an identity resolution value, say based on the correlation between the attributes in the intermediate social customer data 230 and the other data set, say the seed data or the structured organizational customer data 224. In one example, the identity resolution value can be indicative of a similarity between the attributes in the two data sets being compared.

In an example, the identity resolution module 212 can associate an identity resolution value with each attribute of the intermediate social customer data 230, based on the comparison of that attribute with the attribute in the other data set. Accordingly, the identity resolution module 212 can determine an overall identity resolution value based on the comparison of all the attributes in the intermediate social customer data 230 to the attributes in the other data set. In addition, in one case, the identity resolution module 212 can associate a weightage with each attribute, based on a uniqueness of the value of that attribute, and the identity resolution module 212 considers the weightage of the attribute for determining the identity resolution value. For example, the “name” attribute or “father's name” attribute can be given high weightage, since the two attributes are considerably unique. On the other hand, in said example, the “age” attribute or the “sex” attribute can be given low weightage since many individuals can have the same age or sex. Such rules regarding selection of the attributes, the predetermined threshold value of the identity resolution value, and the association of weightages with the attribute can be stored in attribute comparison rules 236 accessible to the identity resolution module 212. It will be understood that while the softkey correlation rules 234 and the attribute comparison rules 236 are shown integrated with the identity resolution module 212, the rules 234 and 236 can alternatively reside in the unification data 220.

Further, in one example, the identity resolution module 212 can compare the identity resolution value against a predetermined threshold value, and on the basis of the comparison, ascertain whether the intermediate social customer data 230 belongs to the same customer as the other data set, or not. Accordingly, data in the intermediate social customer data 230 for which the identity resolution value is greater than or equal to the predetermined threshold value is used further for unification of data. The intermediate social customer data 230 selected for unification, is referred to as refined social customer data 238.

Further, in another implementation of the present subject matter, the identity resolution module 212 can achieve the identity resolution for the customer for intermediate organizational customer data 232 in addition to the intermediate social customer data 230, in the same manner as described above. Accordingly, the intermediate organizational customer data 232 selected for further use, in response to identity resolution, and the structured organizational customer data 224 are collectively referred to as refined organizational customer data 240. In another case, as will be understood, the entire intermediate organizational customer data 232 and the structured organizational customer data 224 are collectively referred to as the refined organizational customer data 240.

Additionally, once the refined customer data 238, 240 are associated with the same customer is identified and selected, then the identity resolution module 212 transfers the refined customer data 238, 240 to the refined data store 110. The refined data store 110 can be the final data store on which the refined customer data 238, 240 is stored. At the refined data store 110, the refined organizational customer data 240 and the refined social customer data 238 are unified to obtain a comprehensive data set regarding the customer. In addition, the identity resolution module 212 can achieve de-duplication of information in the refined organizational customer data 240 and the refined social customer data 238. The additional step of de-duplication achieved by the identity resolution module 212 ensures that the further processing of the refined customer data 230, 232 is smooth and does not consume unnecessary system resources.

Further, the analysis module 214 can use the unified refined customer data set for further purposes. In an example, as mentioned previously, the analysis module 214 can be used for determining an inclination of the customer towards the products and services offered by the organization, inclination of the customer towards products and services offered by a competitor, and view point of the customer regarding similar products and services available in the market.

In an implementation, for the above mentioned processing, the analysis module 214 can apply various data analytics techniques on the refined customer data 238, 240, to determine the inferential attributes. In one example, the analysis module 214 can employ expression handling techniques, event extraction techniques, opinion mining techniques, sentiment analysis techniques, named entity extraction techniques, and social influence indicator techniques, to determine the inferential attributes.

In said example, expression handling techniques are capable of identifying colloquially used abbreviations and emoticons on various portals, say discussion forums, chat rooms, and blogs. For instance, from the texts, the expression handling techniques can identify that the term ‘lyk’ is used for ‘like’, ‘u’ is used for ‘you’, and the emoticon “:-)” for expressing happiness. Therefore, the expression handling techniques can be used to analyze the expressions by replacing these chat abbreviations or emoticons with their actual meanings.

Further, the event extracting techniques can identify life events associated with a customer from the posts on, say social media forums and networking portals. In one example, a life event can be an event which changes a person's circumstances, for example, a new job or moving to a new location. Based on the identification of the life events associated with the customer, the system 102 can provide personalized recommendations to the customer.

Further, in one example, the opinion mining techniques and sentiment analysis techniques involve extraction of opinions and sentiments of the customer from a wide variety of sources, such as reviews, forum discussions, blogs, micro-blogs, and updates on social networking portals. Additionally, the analysis module 214 can apply the named entity extraction techniques to determine whether the customer is referring to the organization, or its products, on any of the various social media channels. In addition, based on the named entity extraction techniques, the analysis module 214 can determine whether the customer has referred to any competitor organization or competitor products on social media forums. For instance, as mentioned previously, the analysis module 214 can apply the opinion mining techniques, sentiment analysis techniques, and named entity extraction techniques to determine whether the customer is advertising or criticizing the products and services offered by the organization, or the competitor, or other aspects relating to the business of the organization.

In addition, the analysis module 214 can apply social influence indicator techniques to determine the influence that the customer can have on other people associated with the customer, say on social media forums, say networking portals, discussion forums, and chat groups. For instance, the social influence indicator techniques can make use of comments posted by users in response to a post or an update by the customer on the social networking portals, or user comments on a blog or an article. Accordingly, the analysis module 214 can determine a social graph for the customer, the social graph being indicative of the social presence and influence of the customer on various social media channels, and also indicate relationship that the customer has with other users on the social media channels.

Further, in one example, the analysis module 214 can apply such data analytics techniques to the refined social customer data 238. In another example, as part of data analytics, the analysis module 214 can apply similar data analytics techniques to the refined organizational customer data 240, say in case the customer is determined to have large influence on social media. In one implementation, for determining the inferential attributes from the refined organizational customer data 240, the analysis module 214 can apply few or all of the above mentioned data analytics techniques to the refined organizational customer data 240, such as call records and emails and chats exchanged with the customer.

Therefore, the analysis module 214 extracts comprehensive details regarding the customer, as mentioned above, from social media data and organizational data associated with the customer. As a result, the analysis module 214 achieves the unification of customer data from various disparate sources of customer data, and stores the unified data for further use. In an example, the analysis module 214 can store the unified customer data in the refined data store 110 in a single row, for access to the output module 216. Accordingly, the output module 216 can access the unified customer data and provide the same in a pictorial representation, for example, on the display unit 112. In said implementation, the output module 216 can have data rendering capabilities for rendering the unified customer data to the display unit 112.

In an example, the output module 216 can render the inferential attributes associated with the customer, determined based on the refined social customer data 238 and the refined organizational customer data 240. In addition, the output module 216 can also render the refined social customer data 238 and the refined organizational customer data 240, say on being requested by a user of the system 102 at the organization. In addition, the output module 216 can integrate the unified customer data and the results of application of data analytics techniques on the unified data, with the business intelligence tools, say for planning business strategies and policies, based on the customer feedback determined from the unified customer data. In another example, the output module 216 can integrate the refined social customer data 238 and the refined organizational customer data 240 with the business intelligence tools, for the same purpose as above.

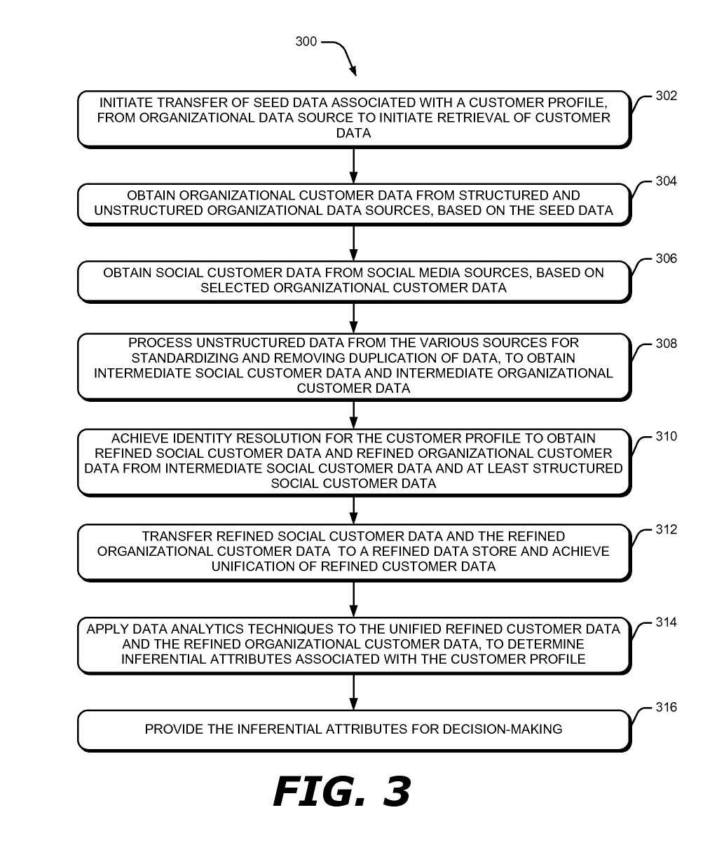

FIG. 3 illustrates a method 300 for a method for unification of customer data of an organization implementing the big data platform 100, according to an implementation of the present subject matter. In one example, the method 300 is carried out by the customer data unification system 102 which can be implemented as the HADOOP cluster in the big data platform 100. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method, or alternative methods. Additionally, individual blocks may be deleted from the method without departing from the spirit and scope of the subject matter described herein. Furthermore, the method can be implemented in any suitable hardware, software, firmware, or combination thereof.

With reference to the description of FIG. 3, for the sake of brevity, the details of the components of the customer data unification system 102 for unification of customer data of an organization, are not discussed here. Such details can be understood as provided in the description provided with reference to FIG. 1, FIG. 2A, and FIG. 2B. As mentioned previously, in operation, the customer data from various sources is brought together, and used for obtaining a comprehensive insight on customer perspective regarding the organization, and the products and services offered by the organization.

Referring to FIG. 3, at block 302, retrieval of the customer data is initiated by intimating transfer of seed data associated with the customer profile, for whom the customer data unification is being performed. In an example, the seed data is retrieved from the organizational data source 104 and can include basic information regarding the customer, say name, date of birth, location, and sex of the customer.

At block 304, based on the seed data, organizational customer data can be obtained from the organizational data source 104, say by parsing such organizational data source 104. In an implementation, the organizational data source 104 can include structured data sources and unstructured data sources, and the organizational customer data can be obtained from both such sources. In an example, the unstructured organizational data sources can include customer relationship communication, say emails, chats, and telephonic conversations, and click stream logs based on the websites browsed by the customer. Further, in one example, the structured organizational data sources can include customer relationship management (CRM) systems and master data management (MDM) systems. The organizational customer data obtained from the organizational data source 104 includes unstructured organizational customer data 226 as well as structured organizational customer data 224.

At block 306, social customer data is obtained from one or more disparate social media sources 106. In one example, the social media sources can include unstructured sources of customer social data, and therefore, the social customer data is obtained in an unstructured format. For instance, the social media sources 106 can include various publically accessible social media channels, including networking portals, blogs, discussion forums, chat groups, and click stream logs of various such portals and forums. In addition, the unstructured social customer data 228 can be obtained from published articles and research papers which include enough information for determining identity of the author, say when the published articles or papers include the name, phone number, and email address of the author. Therefore, the unstructured social customer data 228 can be obtained by parsing the different social media sources 106.

In an implementation, the unstructured social customer data 228 is obtained based on the organizational customer data. In said implementation, certain attributes are selected from the already obtained structured organizational customer data 224 and unstructured organizational customer data 226, and the unstructured social customer data 228 is obtained from the social media sources 106 based on the selected attributes. In another implementation, the unstructured customer data 228 can be obtained based on the seed data.

At block 308, the parsed data from the various data sources, such as organizational data source 104, and social media source 106, is processed for standardization of customer data into a similar format, and removing duplicates from the customer data. In one example, the data operations for standardization and removal of duplicates are performed on the unstructured organizational customer data 226 and the unstructured social customer data 228. The data obtained after performing the above mentioned operations on unstructured social customer data 228 is referred to as intermediate social customer data 230, and the data obtained after performing the above mentioned operations on the unstructured organizational customer data 226 is referred to as the intermediate organizational customer data 232.

Further, the intermediate social customer data 230 and the intermediate organizational customer data 232 can be stored on the intermediate data store 108 for further processing. Accordingly, as will be understood from the foregoing description, the various data sources 104, 106, are parsed to receive the customer data 224, 226, 228 on the big data platform 100, processed for standardization and removal of duplicates, and then the intermediate customer data 230, 232 is stored on the intermediate data store 108 of the big data platform 100.

At block 310, the identity resolution is achieved for the customer, say for the intermediate social customer data 230, to ensure that the unstructured social customer data 228 and the organizational customer data 224, 226 are obtained for the same individual. In an implementation, for identity resolution, a plurality of attributes can be selected, and details regarding each of the selected attributes can be retrieved from the intermediate social customer data 230 and from either the seed data or the structured organizational customer data 224. In an example, the plurality of attributes can be selected from the seed data; in other example, the attributes can be selected from the structured organizational customer data 224. Further, in said implementation, details from the intermediate social customer data 230 and the other data set, i.e., the seed data or the structured organizational customer data 224, for each attribute can be compared to determine the similarity between the two data sets.

In one implementation, the system 102 can ascertain an identity resolution value based on the comparison between the details from the two data sets. In addition, a weight can be associated with each of the individual attributes, based on a uniqueness of value of the selected attribute. For example, the attributes “sex” or “age” can be associated low weight, whereas the attributes “contact number”, “email address”, and “father's name” can be associated high weight because the latter set of attributes may have unique values for each individual. Further, for comparing the attributes and determining the identity resolution values for identity resolution, various techniques can be employed. In an example, for comparing the strings in each data set, softkey correlation techniques can be used.

Further, the identity resolution value determined on comparison of the two data sets is compared against a predetermined threshold value, and the intermediate social customer data 230 for which the identity resolution value is determined to be equal or greater than the threshold value is determined to belong to the same customer for whom the seed data or structured organizational customer data 224 is obtained. Accordingly, such intermediate social customer data 230 is used further in data unification. The intermediate social customer data 230 selected for further use, in response to identity resolution, is referred to as the refined social customer data 238.

Further, in another implementation of the present subject matter, the identity resolution for the customer can also be achieved for intermediate organizational customer data 232 in addition to the intermediate social customer data 230, in the same manner as described above. Accordingly, the intermediate organizational customer data 232 selected for further use, in response to identity resolution, and the structured organizational customer data 224 are collectively referred to as refined organizational customer data 240. In another case, as will be understood, the intermediate organizational customer data 226 and the structured organizational customer data 224 are collectively referred to as the refined organizational customer data 240.

Once the identity resolution is achieved, at block 312, the refined social customer data 238 and the refined organizational customer data 240 can be moved or transferred to a refined data store 110. Therefore, according to an aspect of the present subject matter, at the refined data store 110 a unified data set formed by integrating the refined social customer data 238 and the refined organizational customer data 240, which can be used for obtaining an insight on the customer perspective regarding the products and services of the organization, inclination of the customer towards competitive products, influence of the customer in social media, and viewpoints of the customer on aspects related to the line of business of the organization.

Accordingly, at block 314, data analytics techniques are applied to the unified data set of the refined social customer data 238 and the refined organizational customer data 240, say on the refined data store 110, to determine inferential attributes associated with the customer. As mentioned earlier, the inferential attributes can be indicative of the inclination of the customer towards the products and services offered by the organization, inclination of the customer towards products and services offered by a competitor, and view point of the customer regarding similar products and services available in the market.

In an example, the data analytics techniques can include expression handling techniques, event extraction techniques, opinion mining techniques, sentiment analysis techniques, named entity extraction techniques, and social influence indicator techniques, to obtain the customer perspective from the refined social customer data 230 and the refined organizational customer data 232.

At block 316, the inferential attributes, indicative of the customer perspective, can be provided for decision-making, say for strategizing business models. In an example, the inferential attributes can be rendered on a display unit 112 associated with the big data platform 100, say for the organization to assess the current business processes and planning the business strategies. In another example, the inferential attributes can be integrated with the business intelligence tools for similar purposes. In another case, the inferential attributes, and the refined customer data 238, 240 can either for displayed on the display unit 112, or integrated with the business intelligence tools. In addition, in one case, a report capturing the inferential attributes can be generated and provided to a user, say a decision-maker of the organization, for reference and for use in decision making.

Although implementations for methods and systems for unification of customer data for an organization implementing a big data platform are described, it is to be understood that the present subject matter is not necessarily limited to the specific features or methods described. Rather, the specific features and methods are disclosed as implementations for unification of customer data for an organization implementing the big data platform.

1. A customer data unification system for unification of customer data of an organization, wherein the customer data unification system is implemented in a big data platform, the customer data unification system comprising:
a processor;
a data operation module coupled to the processor to,
obtain organizational customer data and social customer data from one or more organizational data sources and one or more social media sources, respectively, based on seed data associated with a customer profile, wherein the organizational customer data comprises structured organizational customer data and unstructured organizational customer data and wherein the social customer data comprises unstructured social customer data; and
process at least the unstructured organizational customer data and the unstructured social customer data, to obtain intermediate organizational customer data and intermediate social customer data, respectively, wherein the processing comprises at least one of standardization and de-duplication of the unstructured organizational customer data and the unstructured social customer data;
an identity resolution module coupled to the processor to,
obtain refined organizational customer data from the structured organizational customer data and the intermediate organizational customer data;
determine an identity resolution value for at least the intermediate social customer data, based on at least one of the seed data and the structured organizational customer data, the identity resolution value being indicative of a similarity between the organizational customer data and the social customer data; and
select refined social customer data from the intermediate social customer data based on the identity resolution value to unify the refined social customer data with the refined organizational customer data in a refined data store for obtaining customer perspective regarding the organization.

2. The customer data unification system as claimed in claim 1, further comprising an analysis module coupled to the processor to determine inferential attributes associated with the customer profile from the unified refined social customer data and the refined organizational customer data, the determining being based on application of data analytics techniques to the unified refined social customer data and the refined organizational customer data.

3. The customer data unification system as claimed in claim 2, wherein the customer data unification system is coupled to a display unit for displaying the inferential attributes associated with the customer profile.

4. The customer data unification system as claimed in claim 1, wherein the identity resolution module:
selects a plurality of attributes associated with the customer profile from the intermediate social customer data and at least one of the seed data and the structured organizational customer data; and
determines an identity resolution value for each of a plurality of selected attributes.

5. The customer data unification system as claimed in claim 1, wherein the identity resolution module stores the refined organizational customer data and the refined social customer data on the refined data store, for unification of the refined organizational customer data and the refined social customer data.

6. The customer data unification system as claimed in claim 5, wherein the identity resolution module achieves de-duplication of information in the refined organizational customer data and the refined social customer data.

7. The customer data unification system as claimed in claim 1, wherein the data operation module stores the intermediate organizational customer data, the structured organizational customer data, and the intermediate social customer data on an intermediate data store for identity resolution, wherein the intermediate data store is a non-relational, dynamic database.

8. A method for unification of customer data of an organization implementing big data platform, the method comprising:
obtaining organizational customer data and social customer data from one or more organizational data sources and one or more social media sources, respectively, based on seed data associated with a customer profile;
processing the organizational customer data and the social customer data to obtain intermediate organizational customer data and intermediate social customer data, wherein the processing comprises at least one of standardization and de-duplication of unstructured organizational customer data and unstructured social customer data;
obtaining refined organizational
customer data from structured organizational customer data and the intermediate organizational customer data;
determining an identity resolution value for at least the intermediate social customer data, based on at least one of the seed data and the structured organizational customer data, the identity resolution value is indicative of similarity between the intermediate social customer data and the organizational customer data; and
selecting refined social customer data from the intermediate social customer data based on the identity resolution value, to unify the refined social customer data with the refined organizational customer data for obtaining customer perspective regarding the organization.

9. The method as claimed in claim 8, further comprising determining one or more inferential attributes associated with the customer profile by applying data analytics techniques to the unified refined organizational customer data and the refined social customer data.

10. The method as claimed in claim 9, wherein the data analytics techniques comprise at least one of expression handling techniques, event extraction techniques, opinion mining techniques, named entity extraction techniques, sentiment analysis techniques, and social influence indicator techniques.

11. The method as claimed in claim 9, wherein the determining comprises de-duplication of the unified refined organizational customer data and the refined social customer data.

12. The method as claimed in claim 8, wherein the seed data associated with the customer profile is obtained from the one or more organizational data sources, and wherein the seed data comprises basic information regarding the customer.

13. The method as claimed in claim 8, wherein the determining the identity resolution value comprises:
selecting a plurality of attributes associated with the customer profile from the intermediate social customer data and at least one of the seed data and the structured organizational customer data; and
determining an identity resolution value for each of a plurality of selected attributes.

14. The method as claimed in claim 13, wherein the determining comprises associating a weight with each of the plurality of selected attributes, based on a uniqueness of value of the selected attribute.

15. The method as claimed in claim 8, wherein the organizational data sources comprise customer relationship management system, master data management system, customer relationship communication, and click-stream logs.

16. The method as claimed in claim 8, wherein the organizational customer data obtained from the organizational data sources comprises structured organizational customer data and unstructured organizational customer data, and wherein the social customer data comprises unstructured social customer data.

17. A non-transitory computer readable medium having a set of computer readable instructions that, when executed, cause a customer data unification system implemented in a big data platform to:
obtain organizational customer data and social customer data from one or more organizational data sources and one or more social media sources, respectively, based on seed data associated with a customer profile;
process the organizational customer data and the social customer data to obtain intermediate organizational customer data and intermediate social customer data, wherein the processing comprises at least one of standardization and de-duplication of unstructured organizational customer data and unstructured social customer data;
obtain refined organizational customer data from structured organizational customer data and the intermediate organizational customer data;
determine an identity resolution value for at least the intermediate social customer data, based on at least one of the seed data and the structured organizational customer data, the identity resolution value is indicative of similarity between the intermediate social customer data and the organizational customer data;
select refined social customer data from the intermediate social customer data based on the identity resolution value, to unify the refined social customer data with the refined organizational customer data; and
determine, for obtaining customer perspective regarding the organization, one or more inferential attributes associated with the customer profile by applying data analytics techniques to the unified refined organizational customer data and the refined social customer data.

18. The non-transitory computer readable medium as claimed in claim 17, when executed, cause the customer data unification system implemented in the big data platform to determine one or more inferential attributes associated with the customer profile by applying data analytics techniques to the unified refined organizational customer data and the refined social customer data.

19. The non-transitory computer readable medium as claimed in claim 18, when executed, cause the customer data unification system implemented in the big data platform to achieve de-duplication of the unified refined organizational customer data and the refined social customer data.

20. The non-transitory computer readable medium as claimed in claim 17, when executed, cause the customer data unification system implemented in the big data platform to:
select a plurality of attributes associated with the customer profile from the intermediate social customer data and at least one of the seed data and the structured organizational customer data; and
determine an identity resolution value for each of a plurality of selected attributes.
